(19) United States
(12) Patent Application Publication
(10) Pub. No.: US 2024/0042590 A1
(43) Pub. Date: Feb. 8, 2024

(54) Handle for a power tool, power tool, and methods for switching on, switching off and locking same

(71) Applicant: Hilti Aktiengesellschaft, Schaan (LI)

(72) Inventors: Roland MEUER, Ettringen (DE); Michael LANZINGER, Neufraunhofen (DE); Ralf GREITMANN, Kaufering (DE)

(21) Appl. No.: 18/038,477

(22) PCT Filed: Nov. 11, 2021
(86) PCT No.: PCT/EP2021/081394

§ 371 Date: May 24, 2023

(30) Foreign Application Priority Data
Dec. 4, 2020 (EP) 20211904.6

(51) Int. Cl. B25F 5/02; H01H 3/20

(52) U.S. Cl. CPC B25F 5/02; H01H 3/20

(57) ABSTRACT

A handle for a power tool, wherein the handle has a switch-on lock and an operating switch. The handle is characterized in that the switch-on lock is configured to prevent contact between a spring element of the operating switch and an electronic switching element in a blocking position of the switch-on lock and to permit same in an operating position of the switch-on lock. In a second aspect, the invention relates to a power tool having a handle. In further aspects, the invention relates to methods for switching on a power tool and for switching off and locking a power tool, wherein contact between the operating switch and an electronic switching element can be prevented in a blocking position and permitted in an operating position.

The present invention relates to a handle for a power tool, wherein the handle has a switch-on lock and an operating switch.

### BACKGROUND

The prior art includes power tools which are used, for example, to machine substrates or workpieces. Hand-held power tools, in particular, generally have one or more handles, by means of which the power tools can be held and/or guided. In the prior art, it is known that the handles of the power tools comprise operating switches, by means of which a user can switch the power tool on or off, for example. The effect intended to be achieved in the case of power tools of this type is that an undesirable switching on is effectively avoided, in order to reduce possible safety risks for the users. Conventional power tools prevent an unintentional switching on or starting up of the device, for example when carrying or during transport of the device, frequently by means of direct blocking of the switching lever. Transverse slides or button-like switches, with which locking is intended to be brought about, are frequently provided laterally on the handles.

### SUMMARY OF THE INVENTION

However, such laterally mounted locking switches increase the volume of the handle in this region, which may have a disadvantageous effect on the handling of the device.

In order to introduce direct blocking elements and/or switch-on elements of this type into the region of the actual operating lever, a large construction space is generally required for the mechanical lock and the electrical and/or electronic operating components. It follows therefrom that handles are often configured to be significantly more voluminous than would be required for the operability of the power tool. The frequently inappropriately large volume of power tool handles may have an adverse effect on the ergonomics in the grip region of the power tool. In addition, direct blocking of the switching lever may lead to high mechanical loadings for the electronic components involved, which may thereby be damaged.

An object on which the present invention is based is that of overcoming the above-described defects and disadvantages of the prior art and of providing a handle for a power tool that is slender, compact and has good ergonomics. Moreover, those in the industry would welcome it if it were possible, by means of the invention, to protect sensitive components in the handle, such as for example electronic switching elements, from an excessive pressure loading better than in the case of conventional power tools.

According to the invention, a handle for a power tool is provided, wherein the handle has a switch-on lock and an operating switch. The handle is characterized in that the switch-on lock is configured to prevent contact between a spring element of the operating switch and an electronic switching element in a blocking position of the switch-on lock and to permit same in an operating position of the switch-on lock.

By means of the invention, an improved locking possibility for an operating switch of a power tool can be provided, with which at the same time the actual electronic operation is relocated away from the operating switch. This relocation is made possible by the provision of the spring element which preferably has a certain length. For the purposes of the invention, it is preferred that the length of the spring element defines a distance between a switching region of the operating switch and the electronic switching element. The switching region of the operating switch here is the location at which the operating switch is operated (“operating location”), while the location at which the electronic effect of the operation of the operating switch occurs is present in the region of the electronic switching element (“action location”). By means of the spatial separation of operating location and action location, the electronic action location can be shifted out of the grip region of the handle of the power tool, and therefore the grip region can be slender, compact and easy to grip. This improves the ergonomics of the handle and facilitates the handling and the transport of the power tool.

In a preferred refinement of the invention, the handle of the power tool has a C shape which, instead of a continuous rounded portion, has two rounded regions. In the center of the handle, preferably between the two rounded regions, there is the handle grip region which is enclosed by the user's hand, during operation of the power tool, in order to hold and to guide the power tool and in order to make settings by means of the switches provided on the handle. Between the rounded regions and the power tool, the handle has two side parts of the handle. For the purposes of the invention, it is preferred that the part of the operating switch which is visible from the outside is arranged on a bottom side of the grip region and therefore on the side of the handle which faces the power tool, while the switch-on lock is arranged on a top side of the handle, preferably on the front side part of the power tool handle. The part of the operating switch which is visible from the outside is preferably also referred to as the switching region of the operating switch. For the purposes of the invention, it is preferred that the electronic switching element is also present in the front side part of the handle of the power tool, in particular in an interior space of the front side part of the power tool handle. The action location of the operating switch is preferably also located there. The inventors have recognized that, by providing the action location outside the grip region of the power tool handle, a particularly compact, ergonomic configuration of the grip region of the handle of the power tool can be made possible.

A locking or lock of the power tool is achieved by the interaction of a spring element of the operating switch with the switch-on lock. For this purpose, the switch-on lock, which is preferably arranged in the front side part of the power tool handle, can have a blocking geometry. This blocking geometry of the switch-on lock is preferably configured to prevent or to permit contact between the spring element of the operating switch and the electronic switching element. If contact is possible, the power tool can be switched on, and the switch-on lock or the power tool is in an operating position. The user can then switch on the power tool by operating the operating switch on the grip region of the power tool handle and can work with the power tool. The power tool is switched on in particular by operation of the operating switch in an “upward” spatial direction, as a result of which the operating switch rotates about a pivot point in the interior of the handle. For the purposes of the invention, it is preferred that the pivot point is located in the region of a rounded region of the power tool handle. It can be arranged in particular in the rounded region between the front side part of the handle and the grip region. By rotation of the operating switch, the spring element of the operating switch is moved in a “downward” spatial direction. This movement is possible if the switch-on lock or the power tool is in the operating position. The spring element of the operating switch can enter into contact with the electronic switching element by means of the downward movement, as a result of which an internal current circuit of the power tool is closed and the power tool is started or switched on. If the switch-on lock or the power tool is in the blocking position, the blocking geometry of the switch-on lock prevents contact from occurring between the spring element and the electronic switching element, and the internal power tool current circuit from being closed. This blockade is preferably achieved by a lug of the spring element being received by a receiving space in the blocking geometry, as a result of which a downward movement of the spring element in the direction of the electronic switching element is prevented.

For the purposes of the invention, it is preferred that the spring element has an electrically conductive contact region which can be in contact with the electronic switching element in the operating position of the switch-on lock. It is therefore in particular the electrically conductive contact region of the spring element of the operating switch, which contact region can be in contact with the electronic switching element in the operating position of the switch-on lock or the power tool, in order to close the internal power tool current circuit and to permit operation of the power tool.

For the purposes of the invention, it can also be preferred that the spring element does not have an electrically conductive contact region, but rather is configured to operate the electronic switching element. This embodiment is preferred in particular whenever the electronic switching element comprises a microswitch, wherein it is preferred, for the purposes of the invention, that the microswitch is operated by a partial region of the spring element. This operation preferably takes place during a downward movement of the spring element that is caused by operation of the operating switch.

The spring element preferably has a lug which can enter into engagement with the blocking geometry of the switch-on lock in such a manner that contact between the spring element of the operating switch and the electronic switching element can be prevented in a blocking position. The lug of the spring element can be received by a receiving region in the blocking geometry of the switch-on lock such that a movement of the spring element in a “downward” spatial direction and contact between the electrically conductive contact region of the spring element and the electronic switching element are prevented specifically in the blocking position. In the operating position, the lug of the spring element and the blocking geometry are in contact with each other, and therefore the movement of the spring element in the “downward” spatial direction and thus contact between the spring element and electronic switching element are made possible. Tests have shown that, with the locking, an unintentional starting up of the power tool can be effectively and reliably prevented. For the purposes of the invention, it is preferred that the lug is designed as a protruding region of the spring element of the operating switch and is configured to interact with the blocking geometry of the switch-on lock or to be received by a receiving region of the blocking geometry. For the purposes of the invention, it is preferred that the receiving region of the blocking geometry and lug of the spring element are coordinated with each other or correspond to each other in respect of their spatial configuration.

In addition, by means of the invention, the electronic operating elements, such as, for example, the electronic switching element, are effectively protected by the configuration of the operating switch from a possible mechanical overloading. For the purposes of the invention, it is preferred that the spring element of the operating switch is configured to be exposed to a deformation, wherein the deformation of the spring element protects the electronic switching element from a mechanical overload. This is preferably achieved in that the spring element of the operating switch can absorb deformation energy which prevents excessive loading and too great a mechanical pressure on the electronic switching element by the spring element absorbing the compression energy itself. In other words, the deformation of the spring element can protect the electronic switching element from a mechanical overload. The invention therefore leads to the synergistic effect that, firstly, the grip region of the power tool handle can be compact and ergonomically advantageous and, secondly, effective overload protection for the sensitive electronic parts of the handle can be provided.

For the purposes of the invention, it is preferred that the deformability of the spring element of the operating switch makes it possible to prevent contact between the spring element and the electronic switching element in a blocking position. In other words, the spring element of the operating switch can absorb deformation energy, such that a downward movement, i.e. a movement of the spring element in a “downward” spatial direction, is prevented, and therefore an electrically conductive contact region of the spring element of the operating switch cannot enter the region of the electronic switching element. This blockade is referred to, for the purposes of the invention, as locking or a lock of the power tool, wherein the locking can effectively prevent an undesirable switching on of the power tool especially during transport of or when carrying the power tool.

The electronic switching element is preferably present in an interior space of the handle of the power tool. It can comprise one or more microswitches which interact with an electrically conductive contact region of the spring element of the operating switch in such a manner that a current circuit within the power tool is closed. This closing of the current circuit by contact between spring element and electronic switching element preferably brings about switching on of the power tool, while opening of the current circuit by ending the contact between spring element and electronic switching element leads to the power tool being switched off.

For the purposes of the invention, it is preferred that the operating switch may also be referred to as a switch-on lever. It is preferably designed for switching the power tool on and off. For the purposes of the invention, it is preferred that the operating switch has a switching region which is arranged on the grip region of the power tool handle so as to be visible from the outside. Moreover, the operating switch comprises a spring element which is arranged in the interior of the handle and is generally not visible for the user. The user operates the operating switch preferably by grasping the handle of the power tool with one hand, a right-handed person, for example, with the right hand, and using the fingers to exert pressure on the switching region of the operating switch. The operating switch and its switching region are preferably arranged on a second side of the handle, which is preferably a bottom side of the handle and faces the power tool. The first side of the handle is preferably also referred to as the top side of the handle and is preferably located on the side of the handle which faces away from the power tool. The handle can have, for example, a C shape, wherein the bottom side of the handle forms the inner side of the letter C, which preferably faces the power tool. For the purposes of the invention, it is preferred that the switch-on lock is arranged on the first side of the handle, which is preferably a top side of the handle and which forms the outer side of the letter C facing away from the power tool. In other words, it is preferred that the switch-on lock and the operating switch are arranged on different or opposite sides of the handle.

A power tool which comprises a handle constitutes a second aspect of the invention. However, the handle preferably constitutes a device which is independent of the power tool and which, although it interacts with a power tool, can, however, also be purchased individually, for example.

For the purposes of the invention, it is preferred that the operating switch comprises a switching region and the spring element, wherein a pivot point of the operating switch is arranged between the switching region and the spring element of the operating switch. This means that it is preferred, for the purposes of the invention, that the switching region and the spring region of the operating switch are separated from each other by the pivot point of the operating switch. The pivot point is preferably the point about which the components of the operating switch, such as switching region and spring element, can rotate when the operating switch is operated, i.e. pressed. The pivot point is preferably located in the interior of the handle of the power tool. For the purposes of the invention, it is preferred that the pivot point is formed by a substantially cylindrical body onto which an opening within the operating switch can be pulled. In other words, the operating switch comprises an opening having a substantially circular area which is configured for receiving the substantially cylindrical body which is preferably part of the power tool handle.

For the purposes of the invention, it is preferred that the spring element of the operating switch experiences a force in the “downward” spatial direction when the switching region of the operating switch is pressed in the “upward” spatial direction by a user of the power tool. The spatial direction terms are oriented to the first and the second side of the handle of the power tool, which sides, for the purposes of the invention, are preferably also referred to as top side and as bottom side of the handle. The spatial directions “upward” and “downward” and the top side and bottom side of the power tool handle are furthermore illustrated in the figures.

For the purposes of the invention, it is preferred that the blocking geometry as part of the switch-on lock is movable and can be brought from the blocking position into the operating position, and back, by a sliding movement of the switch-on lock. In other words, the switch-on lock can preferably be present in two different positions, wherein the switch-on lock can be transferred from the one position into the other position by a sliding movement. The switch-on lock can be designed in particular as a sliding switch, wherein one position corresponds to the blocking position, in which the power tool cannot be switched on, and the other position corresponds to the operating position, in which operation of the power tool is possible.

For the purposes of the invention, it is preferred that an action location of the operating switch is not located in the immediate spatial vicinity of the operating switch, but rather in a spaced-apart inner region of the handle of the power tool. In other words, the effect of the operating switch by means of the arrangement of spring element and switching region on different sides of the pivot point of the operating switch leads to the action location of the operating switch not being in the immediate spatial vicinity of the operating switch, but rather further away therefrom, preferably at a distance which corresponds to the length of the preferably elongate spring element. For the purposes of the invention, it is preferred in particular that the action location of the operating switch is not located on the side of the switching region of the operating switch, but rather on the other side of the pivot point of the operating switch, namely on the side of the spring element of the operating switch. For the purposes of the invention, it is preferred that the switching region of the operating switch is arranged in the grip region of the power tool switch while the spring element of the operating switch projects into the front side part of the handle. The pivot point is preferably located in the region of the rounded region or transition region between the front side part and the grip region of the power tool handle.

For the purposes of the invention, it is very particularly preferred that the action location of the operating switch coincides with a position of the electronic switching element. This coincidence leads advantageously to the separation intended according to the invention of operating location and action location and to the desired spatial separation thereof, such that the handle of the power tool can be slender and compact.

In further aspects, the invention relates to methods for switching on a power tool and for switching off and locking a power tool, wherein the power tool comprises a handle. The terms, definitions and technical advantages introduced for the handle apply preferably in an analogous manner to the power tool and the methods, and vice versa.

The invention relates in particular to a method for switching on a power tool, wherein the method is characterized by the following steps:
a) providing a power tool,
b) setting an operating position of the switch-on lock,
c) operating the operating switch, wherein the power tool is switched on by operating the operating switch,
d) operating the power tool.

The invention furthermore relates to a method for switching off and locking a power tool, wherein the method is characterized by the following steps:
a) providing a power tool,
b) operating the power tool in an operating position of the switch-on lock, wherein the operating switch is operated by a user during the operation of the power tool,
c) releasing the operating switch, wherein the power tool is switched off by releasing the operating switch,
d) locking the power tool by operating the switch-on lock from the operating position into a blocking position.

For the purposes of the invention, it is preferred that contact between the operating switch and an electronic switching element can be prevented in a blocking position and permitted in an operating position. Moreover, it is preferred that the switch-on lock has a blocking geometry which interacts with a spring element of the operating switch in order to prevent or to permit contact between the spring element and the electronic switching element. For the purposes of the invention, it is preferred that the switch-on lock is operated by a sliding movement of the switch-on lock.

In an exemplary embodiment of the invention, it is preferred that the actual action location of the operating switch and operating location are decoupled from each other. As a result, the locking or the switch-on lock of the power tool and the location of the operating switch can advantageously also be separated spatially from each other. This permits an ergonomically advantageous configuration of the handle or of its grip region which the user grasps during work with the power tool. This spatial separation is achieved by the operating switch which is arranged rotatably within the power tool handle and the spring element of which extends into a front side part of the handle and thus overcomes the distance from the switch-on lock and the electronic switching element that are located in the front side part of the handle. The switching region of the operating switch which is pressed by the user in order, for example, to switch on the power tool is located, by contrast, in the grip region of the power tool handle, preferably in a readily visible manner for the user.

In addition, the electronic operating elements, such as switching element or microswitch, are protected by the configuration of operating switch and switch-on lock from a possible overloading.

For the purposes of the invention, it is preferred that the spring element and the electrically conductive contact region, which can enter into contact with the electronic switching element in order to close an internal power tool current circuit, are arranged on different sides of a pivot point of the operating switch. As a result, the operation of the electronic switching element can be shifted out of the actual switching region of the operating switch. It can in particular be shifted out of the grip region of the power tool handle and into a front side part of the handle. This shifting enables the switch-on lever to have very slender and space-saving design.

The actual contact geometry with the electronic switching element is provided integrally on the operating switch by means of a spring element. The contact geometry comprises the electrically conductive contact region which can enter into contact with the preferably at least one microswitch of the electronic switching element. By means of the preferably resilient configuration of the spring element, it can be ensured that the electronic switching element or the microswitch, on the one hand, is reliably pressed and, on the other hand, is protected against overloading and/or damage. For the purposes of the invention, it is preferred that the spring element is designed as a plastics spring or comprises at least one plastic. The design of the spring element is preferably configured in such a manner that the spring element, in particular because of its spatial configuration and its material strength, has elastic properties which permit the absorption of deformation energy without the spring element itself incurring mechanical damage. The deformability and the elastic properties of the spring element of the operating switch preferably contribute to the particularly effective overload protection of the sensitive electronic components of the handle and, moreover, ensure that contact between spring element and electronic component is avoided in the blocking position of the switch-on lock or the power tool.

The switch-on lock can be designed as a sliding switch and advantageously prevents the contact geometry from being able to press against the electronic switching element or its microswitch in the blocking position. For this purpose, a blocking geometry of the switch-on lock engages between the contact geometry of the operating switch and the electronic switching element. When the operating switch is operated, a lug of the spring element is received by a receiving region of the blocking geometry. In order not to damage the electronic switching element, the path which the contact geometry would have to overcome in order to come into contact with the electronic switching element is converted into deformation of the spring element when the operating switch is operated. In the blocking position, no operation of the electronic switching element or its microswitches therefore takes place. As a result, an undesirable starting up of the power tool can be effectively prevented and the user can be protected against possible safety risks from an undesirable starting of the device.

Advantages of the invention furthermore include an optimized construction space in the switching region of the power tool handle, which thereby has good ergonomics. Moreover, protection of the electronic switch components is made possible by means of the integrated, resilient plastics spring element. The invention manages with a small number of components, which reduces the complexity of the power tool and its susceptibility to error. In particular, reliable locking of the device against unintentionally starting up can be ensured, as can overload protection of the sensitive electronic components in the handle of the power tool.

Further advantages will become apparent from the following description of the figures. The figures, the description and the claims contain numerous features in combination. A person skilled in the art will expediently also consider the features individually and combine them to form useful further combinations.

### BRIEF DESCRIPTION OF THE DRAWINGS

Identical and similar components are denoted by the same reference signs in the figures. In the figures:

FIG. 1 shows a section through a preferred configuration of the handle, with the switch-on lock being in the operating position

FIG. 2 shows a section through a preferred configuration of the handle, with the switch-on lock being in the blocking position.

### DETAILED DESCRIPTION

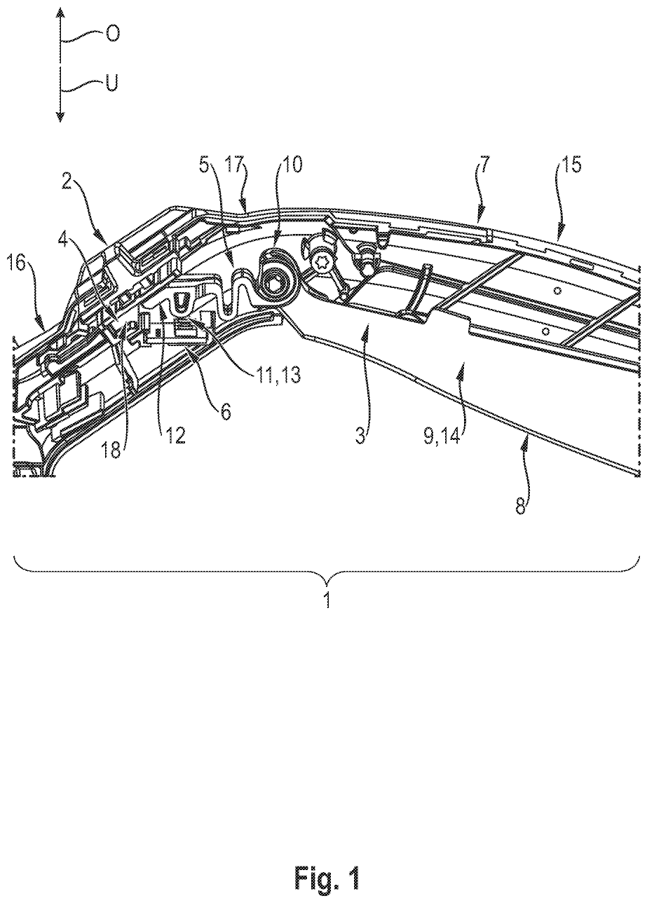

FIG. 1 shows a section through a preferred configuration of the handle 1, with the switch-on lock 2 being in the operating position. The handle 1 can preferably be configured similarly to a letter C, wherein a central region of the handle 1 is referred to as a grip region 15. The user of the power tool can grasp this grip region 15 with one hand, wherein the user's fingers will come to lie on the bottom side 8 of the handle 1, while the palm will rest on the top side 7 of the handle 1. The visible part of the operating lever 3, which is referred to as the switching region 9, is located on the bottom side 8 of the handle 1. The user of the power tool can exert a pressure with their fingers on said switching region 9 in the “upward” spatial direction (0), as a result of which the operating switch 3 is operated. The operating location 14 of the operating switch 3 is therefore located in the region of the switching region 9 of the operating switch 3. The operating location 14 of the operating switch 3 is thus located in particular in the grip region 15 of the power tool handle 1. The “upward” and “downward” spatial directions are depicted by arrows in FIG. 1 and are referred to by the reference signs O and U.

In addition to the switching region 9 which is visible from the outside, the operating switch 3 comprises a spring element 5 which can be designed, for example, as a plastics spring. The spring element 5 preferably has resilient and/or elastic properties and can be deformed. In the process, the spring element 5 can absorb deformation energy. The spring element 5 and the switching region 9 are present on different sides of a pivot point 10 of the operating switch 3. The pivot point 10 is preferably present between the spring element 5 and the switching region 9 and is arranged in an interior space of the handle 1. While the switching region 9 of the operating switch 3 is present in the grip region 15 of the handle 1 of the power tool, the spring element 5 is preferably present in a front side part or side region 16 of the handle 1. The front side region 16 and grip region 15 merge into each other in a rounded region or transition region 17. The pivot point 10 of the operating switch 3 is preferably present in said rounded region 17. The front side region 16 connects the grip region 15 to the power tool or constitutes a connecting element between grip region 15 and power tool. The spring element 5 of the operating switch 3 is preferably elongate and extends into the front side region 16 of the power tool handle 1.

The spring element 5 and the switching region 9 can rotate about the pivot point A virtual axis of rotation which projects out of the drawing plane of the figures preferably runs through the pivot point 10. By operation of the operating switch 3, the switching region 9 is moved in the “upward” spatial direction θ, while the spring element is moved in the “downward” spatial direction. Said downward movement is possible only when the power tool is unlocked. This is the case whenever a switch-on lock 2 of the power tool, which is provided on the handle 1 of the power tool, is in the operating position. By means of the downward movement of the spring element 5, an electrically conductive region 11, which is part of the spring element 5, can enter into contact with the electronic switching element 6. As a result, an internal current circuit of the power tool is closed and the power tool switched on. For the purposes of the invention, the closing of the current circuit is understood as the “effect” of the operation of the operating switch 3. The action location 13 of the operating switch 3 is thus present in the region of the electronic switching element 6, namely where the electrically conductive region 11 of the spring element 5 of the operating switch 3 touches the electronic switching element 6 or enters into contact therewith. Action location 13 and operating location 14 of the operating switch 3 are separated according to the invention, which is referred to for the purposes of the invention as “shifted operation” or as “spatial separation of action location 13 and operating location 14”. By means of this spatial separation, switching and/or transmission elements can be shifted out of the grip region 15 of the power tool handle 1, such that said grip region 15 of the handle 1 can be slender and compact. The resilient and/or elastic properties of the spring element 5 of the operating switch 3 make it possible to prevent too great a mechanical pressure from acting on the electronic switching element 6. In the spring element 5, too great a downward movement can be converted into deformation of the spring element 5, such that an excessive mechanical loading of the electronic switching element 6 is avoided. The electronic switching element 6 can comprise one or more microswitches.

The spring element 5 can have a lug 12 which can be designed as a protruding element and constitutes the outermost region of the spring element 5 that projects the furthest into the front side region 16 of the power tool handle 1. The handle 1 has, in addition to the operating switch 3, a switch-on lock 2 which is arranged on a top side 7 of the handle 1, preferably in the region of the front side part 16 of the handle 1. In FIG. 1, the lug 12 of the spring element 5 and the switch-on lock 2 are present next to each other or in contact with each other and a downward movement of the spring element 5 of the operating switch 3 is possible. As a result, an electrically conductive region 11 of the spring element 5 and the electronic switching element 6 can enter into contact with each other and the internal power tool current circuit can be closed, as a result of which the power tool is switched on.

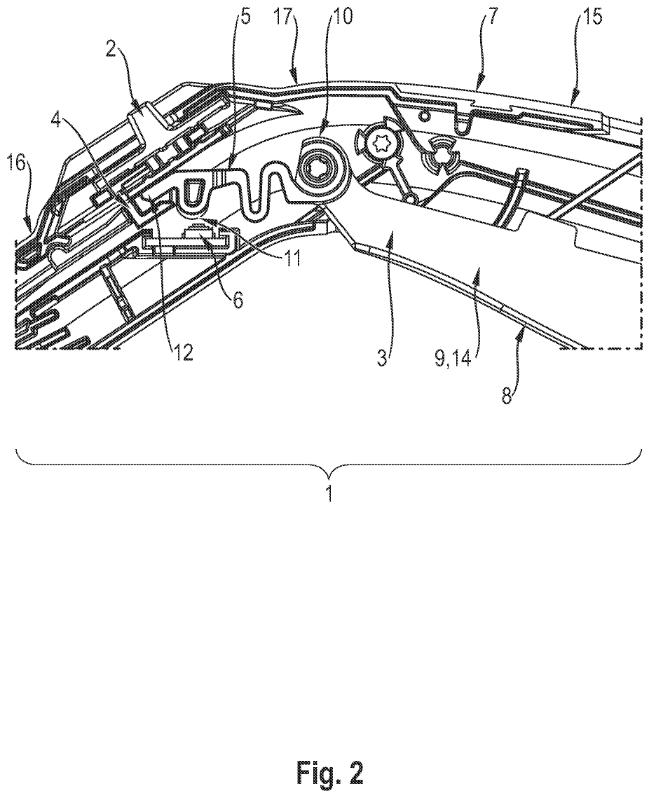

The switch-on lock 2 has a blocking geometry 4 which can interact with the spring element 5 of the operating switch 3. In particular, the lug 12 of the spring element 5 can be received by a receiving space 18 of the blocking geometry 4 of the switch-on lock 2, as a result of which a downward movement of the spring element 5 and contact between the spring element 5 and the electronic switching element 6 are prevented. This blocking position is shown in FIG. 2. In said blocking position, the power tool is locked, and therefore it cannot be switched on. The switch-on lock 2 can be transferred from the blocking position into the operating position by a sliding movement. The switch-on lock 2 is preferably designed as a sliding switch.

### LIST OF REFERENCE SIGNS

1 Handle
2 Switch-on lock
3 Operating switch
4 Blocking geometry
5 Spring element
6 Switching element with microswitch
7 First side of the handle, top side
8 Second side of the handle, bottom side
9 Switching region
10 Pivot point
11 Electrically conductive contact region
12 Lug
13 Action location of the operating switch
14 Operating location
15 Grip region
16 Front side part
17 Rounded region
18 Receiving region
O “Upward” spatial direction
U “Downward” spatial direction

1-15. (canceled)

16. A handle for a power tool, the handle comprising:
a switch-on lock; and
an operating switch having a spring, the switch-on lock configured to prevent contact between the spring and an electronic switch in a blocking position of the switch-on lock and to permit contact between the spring and the electronic switch in an operating position of the switch-on lock.

17. The handle as recited in claim 16 wherein the switch-on lock is present on a first side of the handle and the operating switch on a second side of the handle.

18. The handle as recited in claim 16 wherein the operating switch includes a switching region, and a pivot point of the operating switch is arranged between the switching region and the spring.

19. The handle as recited in claim 16 wherein the spring is configured to be exposed to a deformation so that contact between the spring and the electronic switch is prevented in a blocking position.

20. The handle as recited in claim 19 wherein the deformation of the spring protects the electronic switch from a mechanical overload.

21. The handle as recited in claim 16 wherein the spring has an electrically conductive contact region in contact with the electronic switch in the operating position of the switch-on lock.

22. The handle as recited in claim 16 wherein a blocking geometry as part of the switch-on lock is movable and bringable from the blocking position into the operating position, and vice versa, by a sliding movement of the switch-on lock.

23. The handle as recited in claim 16 wherein the spring has a lug enterable into engagement with the blocking geometry of the switch-on lock so that contact between the spring element of the operating switch and the electronic switch is prevented in a blocking position.

24. The handle as recited in claim 16 wherein an action location of the operating switch and an operating location of the operating switch are separated spatially from each other.

25. The handle as recited in claim 24 wherein the action location of the operating switch coincides with a position of the electronic switch.

26. A power tool comprising the handle as recited in claim 16.

27. A method for switching on the power tool as recited in claim 26, the method comprising the following steps:
a) providing the power tool;
b) setting an operating position of the switch-on lock;
c) operating the operating switch, wherein the power tool is switched on by operating the operating switch; and
d) operating the power tool.

28. The method as recited in claim 27 wherein contact between the operating switch and an electronic switch is prevented in a blocking position and permitted in an operating position.

29. The method as recited in claim 27 wherein the switch-on lock has a blocking geometry interacting with the spring to prevent or to permit contact between the spring element and the electronic switch.

30. A method for switching off and locking a power tool as recited in claim 26, the method comprising the following steps:
a) providing the power tool;
b) operating the power tool in an operating position of the switch-on lock, wherein the operating switch is operated by a user during the operation of the power tool;
c) releasing the operating switch, wherein the power tool is switched off by releasing the operating switch; and
d) locking the power tool by operating the switch-on lock from the operating position into a blocking position.

31. The method as recited in claim 30 wherein contact between the operating switch and an electronic switch is prevented in a blocking position and permitted in an operating position.

32. The method as recited in claim 30 wherein the switch-on lock has a blocking geometry interacting with the spring to prevent or to permit contact between the spring element and the electronic switch.
